(19) United States
(12) Patent Application Publication
(10) Pub. No.: US 2010/0159774 A1
(43) Pub. Date: Jun. 24, 2010

(54) NONWOVEN COMPOSITE AND METHOD FOR MAKING THE SAME

(76) Inventors: Leon Eugene Chambers, JR., Cumming, GA (US); Gabriel Hammam Adam, Alpharetta, GA (US); Reginald Smith, Roswell, GA (US)

Correspondence Address: KIMBERLY-CLARK WORLDWIDE, INC.;Tara Pohlkotte, 2300 Winchester Rd., NEENAH, WI, 54956, US

(21) Appl. No.: 12/339,660

(22) Filed: Dec. 19, 2008

(51) Int. Cl. B32B 5/26; D04H 1/46

(52) U.S. Cl. 442/387; 28/105

(57) ABSTRACT

A nonwoven composite and a method of making a nonwoven composite including lightly bonding and hydroentangling a continuous filament nonwoven web to improve its integrity for subsequent processing steps, such as adding a first layer to the continuous filament nonwoven web and hydroentangling the first layer and the continuous filament nonwoven web together.

### FIELD OF THE INVENTION

The present invention pertains to a nonwoven composite and method, and more particularly to a nonwoven composite including a nonwoven web that is lightly bonded with hot air and hydroentangled, and method for making.

### BACKGROUND OF THE INVENTION

Spunbond fibers are small diameter fibers which are formed by extruding molten thermoplastic material as filaments from a plurality of fine, usually circular capillaries of a spinnerette with the diameter of the extruded filaments being rapidly reduced. Spunbond fibers are generally continuous and have diameters larger than 7 microns, more particularly, between about 10 and 30 microns. The fibers are usually deposited on a moving foraminous belt or forming wire where they form a web.

Spunbond webs have been bonded in some manner immediately as they are produced in order to add to structural integrity for further processing into a finished product. This first step of bonding may be accomplished through the use of an adhesive applied to the fibers as a liquid or powder, which then may be heat activated by, for example, use of compaction rolls.

The web then generally moves on to a more substantial second bonding step where it may be bonded with other nonwoven webs such as, by way of example, spunbond, meltblown, or bonded carded webs, films, woven fabrics, foams, or the like. This step of bonding can be accomplished in a number of ways such as by hydroentangling, needling, ultrasonic bonding, through air bonding, adhesive bonding, thermal point bonding, and calendering.

Compaction rolls are widely used for the first step bonding and have a number of problems. For example, shutdowns caused by the wrapping of the nonwoven web are quite costly. These “compaction wraps” require dismantling and cleaning of the compaction rolls which take a substantial amount of time and effort. This is expensive not only from the point of view of lost or discarded material, but also from the loss of production. Compaction rolls also can force a portion of the polymer into the foraminous belt or forming wire onto which most spunbond webs are formed. This “grinding in” of the polymer can ruin a belt for further use, thus requiring its replacement. Because forming wires are quite long and made of specialized materials, their replacement costs can be quite high and naturally undesirable.

One attempt to avoid this cost is simply not to bond the immediately formed continuous spunbond fibers. However, a problem with this avoidance of cost is that the continuous spunbond fibers tend to move around while moving to the next bonding step, thereby resulting in a finished product having undesirable variations in absorption or other characteristics.

Another attempt to add some integrity to the spunbond fibers is to immediately hydroentangle the fibers for subsequent processing steps. The problem with this attempt is that the hydroentangling of the continuous filaments tends to undesirably move them around on the forming wire, thereby resulting in a product with varying characteristics as described above.

Still another attempt is to bond the immediately formed continuous spunbond fibers with hot air to add some integrity. However, there is less than desirable increase in filament entanglement, since too much hot air can undesirable melt the filaments together.

### SUMMARY OF THE INVENTION

One embodiment of the present invention provides a method of making a nonwoven composite that comprises providing a continuous filament nonwoven web, lightly bonding the continuous filament nonwoven web with hot air, and hydroentangling the lightly bonded continuous filament nonwoven web. Thereafter, the method further comprises providing a first layer on the hydroentangled, lightly bonded continuous filament nonwoven web, and hydroentangling the first layer with the hydroentangled, lightly bonded continuous filament nonwoven web.

In another embodiment of the present invention there is provided a nonwoven composite that comprises a nonwoven web that is lightly bonded with hot air and hydroentangled, and a first layer hydroentangled with the nonwoven web.

The present invention provides optimum entanglement and mobility of the immediately produced continuous filaments by use of lightly bonding with hot air and hydroentangling. This virtually eliminates the undesirable movement of the continuous filaments as they move through the remaining steps of the process. The present invention is particularly advantageous when the continuous filaments have a relatively low basis weight and thus a greater tendency to move around.

### BRIEF DESCRIPTION OF THE DRAWING

The above-mentioned and other features of the present invention and the manner of attaining them will become more apparent, and the invention itself will be better understood by reference to the following description of the invention, taken in conjunction with the accompanying drawing, wherein:

FIG. 1 is a schematic illustration of an apparatus which may be utilized to perform the method and to make the nonwoven composite of the present invention.

### DEFINITIONS

As used herein the term “staple fiber” means discontinuous fibers made from synthetic polymers such as polypropylene, polyester, post consumer recycle (PCR) polyester, nylon, and the like, and may be treated to be hydrophilic. Staple fibers may be meltblown fibers, cut fibers, or the like. Staple fibers can have cross-sections that are round, bicomponent, multicomponent, shaped, hollow, or the like. Typical staple fiber lengths utilized for this invention are 3 to 12 mm with deniers from 1 to 3 dpf.

As used herein the term “pulp fibers” means fibers from natural sources such as woody and non-woody plants. Woody plants include, for example, deciduous and coniferous trees. Non-woody plants include, for example, cotton, flax, esparto grass, milkweed, straw, jute hemp, and bagasse.

As used herein the term “nonwoven web” means a web having a structure of individual fibers or threads which are interlaid, but not in an identifiable manner, as in a knitted fabric. Nonwoven webs have been formed from many processes such as, for example, meltblowing processes, spunbonding processes, and bonded carded web processes. The basis weight of nonwoven webs is usually expressed in ounces of material per square yard (osy) or grams per square meter (gsm) and the fiber diameters are usually expressed in microns. (Note that to convert from osy to gsm, multiply osy by 33.91).

As used herein the term “microfibers” means small diameter fibers having an average diameter not greater than about 75 microns, for example, having an average diameter of from about 0.5 microns to about 50 microns, or more particularly, microfibers may have an average diameter of from about 0.5 microns to about 40 microns. Another frequently used expression of fiber diameter is denier, which is defined as grams per 9000 meters of a fiber. For example, the diameter of a polypropylene fiber given in microns may be converted to denier by squaring, and multiplying the result by 0.00629, thus, a 15 micron polypropylene fiber has a denier of about 1.42 (15.sup.2×0.00629=1.415).

As used herein the term “spunbond” refers to a process in which small diameter fibers are formed by extruding molten thermoplastic material as filaments from a plurality of fine, usually circular capillaries of a spinnerette with the diameter of the extruded filaments then being rapidly reduced as by the process shown, for example, in U.S. Pat. No. 4,340,563 to Appel et al., and U.S. Pat. No. 3,692,618 to Dorschner et al., U.S. Pat. No. 3,802,817 to Matsuki et al., U.S. Pat. Nos. 3,338,992 and 3,341,394 to Kinney, U.S. Pat. No. 3,502,538 to Levy, U.S. Pat. No. 3,502,763 to Hartman, and U.S. Pat. No. 3,542,615 to Dobo et al. Spunbond fibers are generally continuous and have diameters larger than 7 microns, more particularly, between about 10 and 30 microns. Spunbond fibers are generally not tacky when they are deposited onto the collecting surface.

As used herein the term “meltblown” refers to a process in which fibers are formed by extruding a molten thermoplastic material through a plurality of fine, usually circular, die capillaries as molten threads or filaments into converging high velocity gas (e.g. air) streams which attenuate the filaments of molten thermoplastic material to reduce their diameter, which may be to microfiber diameter. Thereafter, the meltblown fibers are carried by the high velocity gas stream and are deposited on a collecting surface to form a web of randomly disbursed meltblown fibers. Meltblown fibers are generally tacky when they are deposited on the collecting surface. Such a process is disclosed, for example, in U.S. Pat. No. 3,849,241 to Butin. Meltblown fibers are microfibers which may be continuous or discontinuous and are generally smaller than 10 microns in diameter.

As used herein the term “meltspun” includes “spunbond” and “meltblown”, and may or may not include bonding.

As used herein the term “polymer” generally includes but is not limited to, homopolymers, copolymers, such as for example, block, graft, random and alternating copolymers, terpolymers, etc. and blends and modifications thereof. Furthermore, unless otherwise specifically limited, the term “polymer” shall include all possible molecular geometrical configurations of the material. These configurations include, but are not limited to isotactic, syndiotactic and random symmetries.

As used herein, the term “machine direction” or “MD” means the length of a fabric in the direction in which it is produced. The term “cross machine direction” or “CD” means the width of fabric, i.e. a direction generally perpendicular to the MD.

As used herein the term “monocomponent” fibers refers to fibers formed from one polymer only. This is not meant to exclude fibers formed from one polymer to which small amounts of additives have been added for coloration, anti-static properties, lubrication, hydrophilicity, and the like. These additives, e.g. titanium dioxide for coloration, are generally present in an amount less than 5 weight percent and more typically about 2 weight percent.

As used herein the term “bicomponent fibers” refers to fibers which have been formed from at least two polymers extruded from separate extruders but spun together to form one fiber. The polymers are arranged in substantially constantly positioned distinct zones across the cross-section of the bicomponent fibers which extend continuously along the length of the bicomponent fibers. The configuration of such a bicomponent fiber may be, for example, a sheath/core arrangement wherein one polymer is surrounded by another, or may be a side by side arrangement, or an “islands-in-the-sea” arrangement.

As used herein the term “biconstituent fibers” refers to fibers which have been formed from at least two polymers extruded from the same extruder as a blend. The term “blend” is defined below. Biconstituent fibers do not have the various polymer components arranged in relatively constantly positioned distinct zones across the cross-sectional area of the fiber, and the various polymers are usually not continuous along the entire length of the fiber, instead usually forming fibrils which start and end at random. Biconstituent fibers are sometimes also referred to as multiconstituent fibers.

As used herein the term “blend” means a mixture of two or more polymers while the term “alloy” means a sub-class of blends wherein the components are immiscible, but have been compatibilized. “Miscibility” and “immiscibility” are defined as blends having negative and positive values, respectively, for the free energy of mixing. Further, “compatibilization” is defined as the process of modifying the interfacial properties of an immiscible polymer blend in order to make an alloy.

As used herein, through air bonding or “TAB” means a process of bonding a nonwoven bicomponent fiber web which is wound at least partially around a perforated roller which is enclosed in a hood. Air which is sufficiently hot to melt one of the polymers of which the fibers of the web are made is forced from the hood, through the web and into the perforated roller. The air velocity is between 100 and 500 feet per minute and the dwell time may be as long as 6 seconds. The melting and resolidification of the polymer provides the bonding. Through air bonding has restricted variability and is generally regarded a second step bonding process. Since TAB requires the melting of at least one component to accomplish bonding, it is restricted to bicomponent fiber webs.

### DETAILED DESCRIPTION

The unique method of the present invention of providing integrity to a nonwoven web for use in a nonwoven composite avoids the use of those methods described above. This invention includes both the use of a “hot air knife” or HAK, and hydroentangling the immediately produced continuous filaments of the nonwoven web.

A hot air knife is a device which focuses a stream of heated air at a very high flow rate, generally from about 1000 to about 10000 feet per minute (fpm) (305 to 3050 meters per minute), directed at the nonwoven web immediately after its formation. The HAK air is heated to a temperature insufficient to melt the polymer in the fiber, but sufficient to soften it slightly. This temperature is generally between about 200° and 550° F. (93. degree. and 290° C.) for the thermoplastic polymers commonly used in spunbonding. A properly controlled HAK, operating under the conditions presented herein, can serve to lightly bond a monocomponent or biconstituent fiber spunbond web without detrimentally affecting web properties and may even improve the web properties, thereby obviating the need for compaction rolls.

The HAK's focused stream of air is arranged and directed by at least one slot of about ⅛ to 1 inches (3 to 25 mm) in width, particularly about ⅜ inch (9.4 mm), serving as the exit for the heated air towards the nonwoven web, with the slot running in a substantially cross machine direction over substantially the entire width of the web. In other embodiments, there may be a plurality of slots arranged next to each other or separated by a slight gap. The at least one slot is preferably, though not essentially, continuous, and may be comprised of, for example, closely spaced holes.

The HAK has a plenum to distribute and contain the heated air prior to its exiting the slot. The plenum pressure of the HAK is preferably between about 1.0 and 12.0 inches of water (2 to 22 mmHg), and the HAK is positioned between about 0.25 and 10 inches and more preferably 0.75 to 3.0 inches (19 to 76 mm) above the forming wire. In a particular embodiment, the HAK's plenum size, as shown in FIG. 2, is at least twice the cross sectional area for CD flow relative to the total exit slot area.

Since the foraminous forming wire onto which the polymer is formed generally moves at a high rate of speed, the time of exposure of any particular part of the nonwoven web to the air discharged from the hot air knife is less a tenth of a second and generally about a hundredth of a second, in contrast with the through air bonding process which has a much larger dwell time. The HAK process has a great range of variability and controllability of at least the air temperature, air velocity and distance from the HAK plenum to the nonwoven web.

As mentioned above, the spunbond process resulting in continuous filaments uses thermoplastic polymers which may be any known to those skilled in the art. Such polymers include polyolefins, polyesters, polyurethanes and polyamides, and mixtures thereof, more particularly polyolefins such as polyethylene, polypropylene, polybutene, ethylene copolymers, propylene copolymers and butene copolymers. Polypropylenes that have been found useful include, for example, polypropylene available from the Himont Corporation of Wilmington, Del., under the trade designation PF-304, polypropylene available from the Exxon Chemical Company of Baytown, Tex. under the trade designation Exxon 3445 and polypropylene available from the Shell Chemical Company of Houston, Tex. under the trade designation DX 5A09. The continuous filaments can have cross-sections that are round, bicomponent, side-by-side, shaped, hollow, or the like, with typical deniers from 1 to 3 dpf.

The hydroentangling may be accomplished utilizing conventional hydroentangling equipment well known in the art. Such hydroentangling equipment can be obtained from Fleissner GmbH of Egelsbach, Germany, or other well known manufacturers. The hydroentangling of the present invention may be carried out with any appropriate working fluid such as, for example, water. The working fluid flows through a manifold which evenly distributes the fluid to a series of individual holes or orifices. These holes or orifices may be from about 0.003 to about 0.015 inch in diameter. For example, the invention may be practiced utilizing a manifold containing a strip having 0.007 inch diameter orifices, 30 holes per inch, and 1 row of holes. Many other manifold configurations and combinations may be used. For example, a single manifold may be used or several injectors may be arranged in succession.

In the hydroentangling process, the working fluid passes through the orifices at a pressures ranging from about 200 to about 2000 pounds per square inch gage (psig). At the upper ranges of the described pressures it is contemplated that the material or materials, such as a nonwoven web, may be processed at speeds of about 1000 feet per minute (fpm). The fluid impacts the material which are supported by a foraminous surface or wire which may be, for example, a single plane mesh having a mesh size of from about 40.times.40 to about 100.times.100. The foraminous surface may also be a multi-ply mesh having a mesh size from about 50.times.50 to about 200.times.200. As is typical in many water jet treatment processes, vacuum slots may be located directly beneath the hydro-needling injectors or beneath the foraminous entangling surface downstream of the hydroentangling manifold so that excess water is withdrawn from the hydroentangled material or materials.

Although the inventors should not be held to a particular theory of operation, it is believed that the columnar jets of working fluid which directly impact fibers laying on the continuous filament nonwoven web work to drive those fibers into and partially through the matrix or nonwoven network of filaments in the web. When the fluid jets and fibers interact with a continuous filament nonwoven web, the fibers are entangled with filaments of the nonwoven web and with each other.

The energy of the fluid jets that impact the fibers and web may be adjusted so that the fibers are inserted into and entangled with the continuous filament nonwoven web in a manner suitable for the use of the end product.

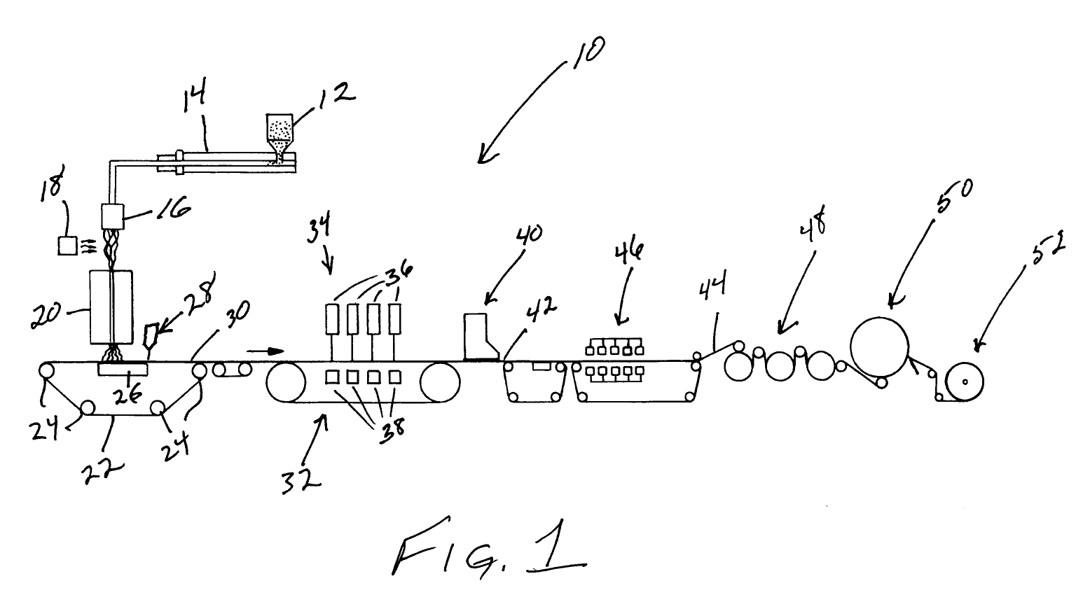

Referring to FIG. 1, there is schematically illustrated at 10 an exemplary process for providing optimum integrity to a nonwoven web for a nonwoven composite in accordance with the principles of the present invention. Polymer is added to hopper 12 from which it is fed into extruder 14. Extruder 14 melts the polymer and forces it into spinnerette 16. Spinnerette 16 has openings arranged in one or more rows forming a downwardly extending curtain of continuous filaments when the polymer is extruded. Air from quench blower 18 quenches the continuous filaments as they leave spinnerette 16. A fiber draw unit 20 is positioned below spinnerette 16 for receiving the quenched filaments. An endless, generally foraminous forming surface 22, which travels around guide rollers 24, receives the continuous filaments from fiber draw unit 20, and vacuum 26 draws the continuous filaments against forming surface 22, thereby forming a continuous filament nonwoven web 30. Immediately after formation, hot air is directed through the continuous filament nonwoven web from hot air knife (HAK) 28 to lightly bond the filaments without detrimentally affecting filament properties. This is important since it is desirable not to substantially distort the filaments. In other words, there is no mechanical deformation of the filaments, thereby resulting in higher strength as compared to methods that do mechanically deform filaments. This results in optimizing the winding, transporting, and unwinding of the nonwoven web when necessary due to manufacturing needs, as further described below.

Thereafter, nonwoven web 30 is moved by conveyor assembly 32 to hydroentangling station 34 where it is selectively hydroentangled by water jets provided by injectors 36. Vacuum modules 38, which may be located directly beneath injectors 36 or downstream therefrom, withdraw excess water, from hydroentangled web 30. One significant and advantageous effect in the hydroentangling of web 30 at this point is that the hydroentangling selectively breaks some of the bonds created by the HAK, thereby resulting in the continuous filaments becoming more flexible and mobile, and thus increasing the filaments entanglement together. This effect is particularly realized in any subsequent hydroentangling of web 30 with other layers in that it provides increased integrity and strength to the resulting product. Furthermore, using the HAK and hydroentangling steps provides a broader effective and useable range of subsequent hydroentangling pressures on nonwoven web 30 without causing substantial disruption of its filaments resulting in the aforementioned increased integrity and strength.

Another advantage of the present invention concerns the need to be able to wind a roll of a continuous filament nonwoven web for transporting to and unwinding at another location for subsequent processing. This need can occur when the various processing steps cannot occur in one on-line process. This makes it necessary to wind the nonwoven web onto a roll for transporting to and unwinding at the next processing point. Because of the nonwoven web's increased integrity and strength, less, or no, damage is done to the nonwoven web. Nonwoven web 30 may be wound after the HAK step and then transported, or may be wound after both the HAK and hydroentangling steps and then transported.

Nonwoven web 30 is then moved to material supply station 40 where a first layer 42 of a select material, or materials, is provided on web 30. First layer 42 can include any material desired for the end use of the final product. Examples of a material include pulp fibers, staple fibers, individual layers of pulp fibers and staple fibers, or a mixture of pulp fibers and staple fibers. Additionally, first layer 42 can be a continuous filament nonwoven web such as, by way of example only, nonwoven web 30. Layer 42 can include a continuous filament nonwoven web and fibers or a mixture of fibers, such as those earlier described above. Thereafter, web 30 and first layer 42 are moved to a second hydroentangling station 46 where both web 30 and layer 42 are hydroentangled together to form nonwoven composite 44. An example of one nonwoven composite 44 of the present invention includes pulp fibers and staple fibers, in which continuous filament nonwoven web 30 comprises 15% to 30% by weight of the nonwoven composite 44; the staple fibers comprise 20% to 35% by weight of the nonwoven composite 44; and the pulp fibers comprise 45% to 65% by weight of the nonwoven composite 44

The present invention further contemplates layers in addition to first layer 42. For example, a second layer (not shown) can be provided from another supply station (not shown) onto first layer 42 for subsequent processing, such as hydroentangling, with web 30 and first layer 42. This second layer may, or may not, be a continuous filament nonwoven web that has been both lightly bonded with hot air and hydroentangled, or only lightly bonded with hot air, or only hydroentangled. As can be appreciated, numerous combinations of layers and materials are contemplated by the method of the present invention to produce numerous finished products.

While this invention has been described as having a preferred embodiment, it will be understood that it is capable of further modifications. It is therefore intended to cover any variations, equivalents, uses, or adaptations of the invention following the general principles thereof, and including such departures from the present invention as come or may come within known or customary practice in the art to which this invention pertains and fall within the limits of the appended claims.

What is claimed is:

1. A method of making a nonwoven composite, comprising the steps of:
providing a continuous filament nonwoven web,
lightly bonding the continuous filament nonwoven web with hot air,
hydroentangling the lightly bonded continuous filament nonwoven web,
providing a first layer on the hydroentangled, lightly bonded continuous filament nonwoven web, and
hydroentangling the first layer with the hydroentangled, lightly bonded continuous filament nonwoven web.

2. The method of claim 1 further comprising the steps of
winding the lightly bonded continuous filament nonwoven web onto a roll,
transporting the roll of the lightly bonded continuous filament nonwoven web, and
unwinding the roll of lightly bonded continuous filament nonwoven web prior to the step of hydroentangling.

3. The method of claim 1 further comprising the steps of
winding the lightly bonded, hydroentangled continuous filament nonwoven web onto a roll,
transporting the roll of the lightly bonded, hydroentangled continuous filament nonwoven web, and
unwinding the roll of hydroentangled, lightly bonded continuous filament nonwoven web prior to the step of providing a layer.

4. The method of claim 1 wherein the step of providing a first layer includes providing pulp fibers.

5. The method of claim 1 wherein the step of providing a first layer includes providing staple fibers.

6. The method of claim 5 wherein the step of providing a first layer further includes providing pulp fibers.

7. The method of claim 1 wherein the step of providing a first layer includes providing a mixture of pulp fibers and staple fibers.

8. The method of claim 1 wherein the step of providing a first layer includes providing a continuous filament nonwoven web.

9. The method of claim 1 wherein the step of providing a first layer includes providing a continuous filament nonwoven web and fibers selected from the group consisting of pulp fibers, staple fibers, and a mixture of pulp fibers and staple fibers.

10. The method of claim 1 wherein the step of hydroentangling the lightly bonded continuous filament nonwoven web further includes breaking some of the bonds of the lightly bonded continuous filament nonwoven web.

11. The method of claim 1 further comprising the step of providing a second layer, and then hydroentangling the first layer and the second layer with the hydroentangled, lightly bonded continuous filament nonwoven web.

12. The method of claim 11 wherein the second layer is a continuous filament nonwoven web.

13. The method of claim 12 wherein the second layer is lightly bonded with hot air.

14. The method of claim 12 wherein the second layer is hydroentangled.

15. A nonwoven composite made by the method of claim 1.

16. A nonwoven composite, comprising:
a continuous filament nonwoven web that is lightly bonded with hot air and hydroentangled, and
a first layer hydroentangled with the continuous filament nonwoven web.

17. The nonwoven composite of claim 16 wherein the first layer consists of fibers selected from the group consisting of pulp fibers, staple fibers, and a mixture of pulp fibers and staple fibers.

18. The nonwoven composite of claim 16 wherein the first layer is a continuous filament nonwoven web.

19. The nonwoven composite of claim 16 wherein the first layer is a continuous filament nonwoven web and fibers selected from the group consisting of pulp fibers, staple fibers, and a mixture of pulp fibers and staple fibers.

20. The nonwoven composite of claim 16 further comprising a second layer hydroentangled with the first layer and the continuous filament nonwoven web.

21. The nonwoven composite of claim 20 wherein the second layer is a continuous filament nonwoven web.

22. The nonwoven composite of claim 21 wherein the second layer is lightly bonded with hot air.

23. The nonwoven composite of claim 22 wherein the second layer is hydroentangled.

24. The nonwoven composite of claim 16 wherein the first layer includes pulp fibers and staple fibers, and wherein the continuous filament nonwoven web comprises 15% to 30% by weight of the nonwoven composite; the staple fibers comprise 20% to 35% by weight of the nonwoven composite; and the pulp fibers comprise 45% to 65% by weight of the nonwoven composite.
